(19) United States
(12) Patent Application Publication
(10) Pub. No.: US 2013/0018592 A1
(43) Pub. Date: Jan. 17, 2013

(54) Systems and Methods for Inter-Population Neurobehavioral Status Assessment Using Profiles Adjustable to Testing Conditions

(71) Applicants: Daniel Joseph Mollicone, Philadelphia, PA (US); Kevin Gar Wan, Philadelphia, PA (US); Christopher Grey Mott, Seattle, WA (US)

(72) Inventors: Daniel Joseph Mollicone, Philadelphia, PA (US); Kevin Gar Wan, Philadelphia, PA (US); Christopher Grey Mott, Seattle, WA (US)

(73) Assignee: Pulsar Informatics, Inc., Philadelphia, PA (US)

(21) Appl. No.: 13/550,522

(22) Filed: Jul. 16, 2012

Related U.S. Application Data
(60) Provisional application No. 61/508,270, filed on Jul. 15, 2011.

(51) Int. Cl. G06F 19/00

(52) U.S. Cl. 702/19

(57) ABSTRACT

Systems and methods for inter-population assessment of neurobehavioral status employ neurobehavioral profiles to accommodate differing external conditions. Population profiles and external condition data are provided to a neurobehavioral performance model to determine neurobehavioral status under external conditions. Alternatively, neurobehavioral performance values may be retrieved from the profile when such values are stored in conjunction with external condition data. Comparisons of the resulting neurobehavioral status(es) are then determined, and may comprise without limitation one or more of: performance deltas, statistical parameter differences, rankings, above/below performance threshold determinations, pass/fail indicators, and countermeasure recommendations. Populations may comprise pluralities, individuals and empty (“null”) sets. Comparisons may also pertain to one or more relevant times of interest and one or more sets of testing conditions. Fields of application include (without limitation) operational and military fatigue management, medical diagnosis and treatment, fatigue countermeasure training and individualization, sleep research, academic and scientific research, and/or the like.

### RELATED APPLICATIONS

This application claims the benefit of the priority of U.S. provisional patent application No. 61/508,270 filed 15 Jul. 2011, which is hereby incorporated herein by reference.

### TECHNICAL FIELD

The invention relates to assessing the neurobehavioral status, as identified under a variety of specifiable testing conditions, of a first population of individuals relative to a second population of individuals using neurobehavioral profiles for the first and second populations respectively. Intra-population comparisons facilitate a variety of applications including medical diagnosis and treatment, management of neurobehavioral deficits related to fatigue, individualization of neurobehavioral training regimens, operational and military management, scientific and academic research, and/or the like.

### BACKGROUND

Neurobehavioral deficits may be associated with medical conditions, medical disorders, drugs, fatigue, or other factors. For instance fatigue may result from any of a number of factors, including extended wakefulness, night work, shift work, extended duty periods, circadian misalignment, jet lag, or chronic sleep loss. In order to effectively identify, monitor, treat, and/or mitigate neurobehavioral deficits and/or make use of neurobehavioral deficit information one must be able to quantify the degree of neurobehavioral deficits in meaningful terms. Approaches to quantifying neurobehavioral status and the degree of neurobehavioral deficits (also known as “neurobehavioral status”) are required in many applications, such as (without limitation) medical monitoring, medical diagnosis, medical screening, medical treatment, scientific experiments, population-based studies, case studies, fatigue risk management in operational settings, academic, and athletic activities.

In many operational settings, for instance, it may be difficult to establish fitness-for-duty thresholds for neurobehavioral status of the operator that are expressed in absolute terms of numerical test metrics from an neurobehavioral assessment or numerical results derived from a biomathematical model that estimates neurobehavioral status.

For instance, readily identifiable neurobehavioral performance standards for particular tasks or assignments are not always articulable with needed accuracy (e.g., the biomathematical model estimates of pilot fatigue levels relative to policy-based limits for safe operation of the aircraft, the maximum number of allowed PVT lapses to operate a commercial motor vehicle, etc.). Nor are the identification of sufficient countermeasures to mitigate neurobehavioral defects when test scores or biomathematical model outputs indicate a neurobehavioral deficit. When the external conditions (e.g., sleep history, countermeasures, environmental factors, etc.) under which a particular task or assignment are to be performed differ from those under which neurobehavioral state was measured or predicted, moreover, the aforementioned difficulties are compounded even further. Therefore, there is a general desire for approaches to compare neurobehavioral status of a given population of (one or more) individuals to a control population of (one or more) individuals, where the neurobehavioral performance of the control population is familiar or readily known. A further need exists for approaches to compare a population to itself under different external conditions, and to compare individuals to themselves and other individuals across different sets of external conditions and at differing time periods of interest.

### SUMMARY

One aspect of the invention provides a method employing neurobehavioral profiles with a computer for determining a comparison of the neurobehavioral status of a first population relative to the neurobehavioral status of a second population, the method comprising: receiving, at a computer, a first neurobehavioral profile for a first population, the first neurobehavioral profile indicating a neurobehavioral status of the first population corresponding to a set of testing conditions; receiving, at the computer, a second neurobehavioral profile for a second population, the second neurobehavioral profile of indicating a neurobehavioral status of the second population corresponding to a set of testing conditions; receiving, at the computer, a first set of testing-condition data, the first set of testing-condition data being indicative of a first set of testing conditions; determining, with the computer, a neurobehavioral status for the first population associated with the first set of testing conditions, wherein the neurobehavioral status for the first population associated with the first set of testing conditions is based at least in part on the received first neurobehavioral profile and the received first set of testing-condition data; determining, with the computer, a neurobehavioral status for the second population associated with the first set of testing conditions, wherein the neurobehavioral status for the second population associated with the first set of testing conditions is based at least in part on the received second neurobehavioral profile and the received first set of testing-condition data; and determining, with the computer, a comparison of the determined neurobehavioral status of the first population associated with the first set of testing conditions relative to the determined neurobehavioral status of the second population associated with the first set of testing conditions.

Another aspect of the invention provides a computer program product embodied in a non-transitory medium and comprising computer-readable instructions that, when executed by a suitable computer, cause the computer to perform a method for determining a comparison of the neurobehavioral status of a first population relative to the neurobehavioral status of a second population, the method comprising: receiving, at a computer, a first neurobehavioral profile for a first population, the first neurobehavioral profile indicating a neurobehavioral status of the first population corresponding to a set of testing conditions; receiving, at the computer, a second neurobehavioral profile for a second population, the second neurobehavioral profile of indicating a neurobehavioral status of the second population corresponding to a set of testing conditions; receiving, at the computer, a first set of testing-condition data, the first set of testing-condition data being indicative of a first set of testing conditions; determining, with the computer, a neurobehavioral status for the first population associated with the first set of testing conditions, wherein the neurobehavioral status for the first population associated with the first set of testing conditions is based at least in part on the received first neurobehavioral profile and the received first set of testing-condition data; determining, with the computer, a neurobehavioral status for the second population associated with the first set of testing conditions, wherein the neurobehavioral status for the second population associated with the first set of testing conditions is based at least in part on the received second neurobehavioral profile and the received first set of testing-condition data; and determining, with the computer, a comparison of the determined neurobehavioral status of the first population associated with the first set of testing conditions relative to the determined neurobehavioral status of the second population associated with the first set of testing conditions.

Another aspect of the invention provides a system for determining a comparison of the neurobehavioral status of a first population relative to the neurobehavioral status of a second population, the system comprising: a data storage unit, the data storage unit containing a database of neurobehavioral profiles and a database of testing-condition data, and a processor capable of receiving neurobehavioral profiles and testing-condition data from the data storage unit, wherein determining a comparison of the neurobehavioral status of a first population relative to the neurobehavioral status of a second population comprises: receiving, at the computer, a first neurobehavioral profile for a first population, the first neurobehavioral profile being capable of indicating a neurobehavioral status of the first population corresponding to a set of testing conditions; receiving, at the computer, a second neurobehavioral profile for a second population, the second neurobehavioral profile being capable of indicating a neurobehavioral status of the second population corresponding to a set of testing conditions; receiving, at the computer, a first set of testing-condition data, the first set of testing-condition data being indicative of a first set of testing conditions corresponding to a first time of interest; determining, with the computer, a neurobehavioral status for the first population associated with the first set of testing conditions, wherein the neurobehavioral status for the first population associated with the first set of testing conditions is based at least in part on the received first neurobehavioral profile and the received first set of testing-condition data; determining, with the computer, a neurobehavioral status for the second population associated with the first set of testing conditions, wherein the neurobehavioral status for the second population associated with the first set of testing conditions is based at least in part on the received second neurobehavioral profile and the received first set of testing-condition data; and determining, with the computer, a comparison of the determined neurobehavioral status of the first population associated with the first set of testing conditions relative to the determined neurobehavioral status of the second population associated with the first set of testing conditions.

Further details, features and aspect of particular embodiments are provided in the description below and in the drawings appended hereto.

### BRIEF DESCRIPTION OF DRAWINGS

Exemplary embodiments are illustrated in referenced figures of the drawings. It is intended that the embodiments and figures disclosed herein are to be considered illustrative rather than restrictive.

In drawings which illustrate non-limiting embodiments:

FIG. 1 is a flowchart for a method 100 for determining a comparison of the neurobehavioral response of a first population relative to the neurobehavioral response of a second population, in accordance with a particular embodiment;

The multiple views of FIG. 2 provide exemplary embodiments of a neurobehavioral profile, in accordance particular embodiments of the presently disclosed invention, in which specifically:

FIG. 2A is an illustration of a neurobehavioral profile comprising the distributions of an exemplary (and non-limiting) four (4) neurobehavioral traits distributed across a hypothetical population, in accordance with a particular embodiment;

FIG. 2B is an illustration of a neurobehavioral profile comprising the distribution of a single neurobehavioral trait across a population, in accordance with a particular embodiment; and

FIG. 2C illustrates how the neurobehavioral profile of FIG. 2B may be used to provide a comparative assessment of the neurobehavioral state of a hypothetical testing subject, in accordance with a particular embodiment;

FIG. 2D is an illustration of a neurobehavioral profile comprising one or more neurobehavioral status values each corresponding to a set of testing conditions, in accordance with a particular embodiment;

The multiple views of FIG. 3 provide exemplary embodiments of comparisons of the neurobehavioral status of a first population with respect to a second population comprising an individual, in accordance with particular embodiments of the presently disclosed invention, in which specifically:

FIG. 3A is a multi-day graph of the neurobehavioral status of a population receiving eight (8) hours of sleep per day, according to a particular embodiment;

FIG. 3B is a multi-day graph of the neurobehavioral status of an individual receiving six (6) hours of sleep per day, according to a particular embodiment; and

FIG. 3C is a non-limiting exemplary comparison of the neurobehavioral statuses of the population of FIG. 3A and the individual of FIG. 3B, according to a particular embodiment;

The multiple views of FIG. 4 provide exemplary embodiments of comparisons of the neurobehavioral status of a first population comprising a first individual with respect to a second population comprising a second individual, in accordance with particular embodiments of the presently disclosed invention, in which specifically:

FIG. 4A is a multi-day graph of the neurobehavioral status of an individual (individual A) receiving eight (8) hours of sleep per day, according to a particular embodiment; and

FIG. 4B is a multi-day graph of the neurobehavioral status of an another individual (individual B) receiving eight (8) hours of sleep per day, according to a particular embodiment;

The multiple views of FIG. 5 provide exemplary embodiments of comparisons of the neurobehavioral status of a first population with respect to a second population, in accordance with particular embodiments of the presently disclosed invention, in which specifically:

FIG. 5A is a multi-day graph of the neurobehavioral status of a population (population A) receiving six (6) hours of sleep per day, according to a particular embodiment;

FIG. 5B is a multi-day graph of the neurobehavioral status of another population (population B) receiving six (6) hours of sleep per day, according to a particular embodiment;

FIG. 5C is a non-limiting exemplary comparison of the neurobehavioral statuses of the population of FIG. 5A (population A) and the population of FIG. 5B (population B), according to a particular embodiment; and

FIG. 5D is another non-limiting exemplary comparison of the neurobehavioral statuses of the population of FIG. 5A (population A) and the population of FIG. 5B (population B), according to a particular embodiment;

The multiple views of FIG. 6 provide exemplary embodiments of comparisons of the neurobehavioral status of a first population comprising an individual with respect to a second population, in accordance with particular embodiments of the presently disclosed invention, in which specifically:

FIG. 6A is a multi-day graph of the neurobehavioral status of an individual receiving seven (7) hours of sleep per day, according to a particular embodiment;

FIG. 6B is a multi-day graph of the neurobehavioral status of a population receiving seven (7) hours of sleep per day, according to a particular embodiment;

FIG. 6C is a non-limiting exemplary comparison of the neurobehavioral statuses of the individual of FIG. 6A and the population of FIG. 6B, according to a particular embodiment; and

FIG. 6D is another non-limiting exemplary comparison of the neurobehavioral statuses of the individual of FIG. 6A and the population of FIG. 6B, according to a particular embodiment;

FIG. 7 is a block diagram of an exemplary system 700 for carrying out the methods of the presently disclosed invention, in accordance with a particular embodiment; and

FIG. 8 is a plot showing the variation in the homeostatic process of a typical subject over the transitions between being asleep and being awake, in accordance with particular embodiments.

### DETAILED DESCRIPTION

Before the embodiments of the invention are explained in detail, it is to be understood that the invention is not limited in its application to the details of construction and the arrangements of the operative components set forth in the following description or illustrated in the drawings. The invention is capable of other embodiments and of being practiced or being carried out in various ways. Also, it is understood that the phraseology and terminology used herein are for the purpose of description and should not be regarded as limiting. The use herein of “including” and “comprising,” and variations thereof, is meant to encompass the items listed thereafter and equivalents thereof. Unless otherwise specifically stated, it is to be understood that steps in the methods described herein can be performed in varying sequences and may be repeated a multiplicity of times in varying orders.

### Background to Neurobehavioral Performance

Aspects of the presently disclosed invention relate to particular nuances of neurobehavioral performance. Broadly defined, “neurobehavioral performance” refers to an individual's ability to perform a specific task that requires one or more cognitive functions that rely on fatigue level and/or fatigue state. Such cognitive functions include (without limitation) concentration, short-term or long-term memory, visual or other sensory acuity, alertness, gross motor dexterity, fine motor skill, and/or the like. As used herein, the terms (used interchangeably) “neurobehavioral performance prediction(s),” “predicted neurobehavioral performance,” and “predicted neurobehavioral performance level(s)” refer to the output of a biomathematical model capable of modeling and/or predicting neurobehavioral performance status when given appropriate inputs. Non-limiting factors that may impact a subject's neurobehavioral performance include: sleep disruption, sleep restriction, circadian misalignment, sleep inertia, extended task performance, extended work/duty hours, multitasking, (extended) physical exertion, psychological stresses (e.g., time pressure; family, financial, or legal issues etc.), environmental stressors (e.g., extreme temperature or humidity conditions, ambient noise, ambient vibration, ambient light conditions, altitude “hypoxia” etc.), certain medical conditions or behavioral disorders (e.g., Parkinson's, Alzheimer's, dementia, or any age-related brain dysfunction or mild cognitive impairment, brain injuries, mood disorders, and certain psychoses, etc.), certain drugs, and/or the like.

### Methods to Test Neurobehavioral Performance Generally

The presently disclosed invention may make use of any methods or techniques used to measure neurobehavioral performance. Such methods and techniques may include context-relative performance tasks, such as a workplace-specific task (e.g., assembling X number of specific product units in a particular factory in time T and/or the like), standardized line-of-work specific tasks (e.g., typing a standard document within an acceptable accuracy threshold on standard equipment, and/or the like), and so-called “special tasks” that highlight particular neurobehavioral performance characteristics (e.g., executing a specific complex driving, flying, or navigation maneuver within an acceptable threshold, navigating a standardized obstacle course on foot, assembling a particular standardized complex manufactured object, and/or the like). Performance measures for such neurobehavioral tasks may come from direct human observation, measurement instruments, or from embedded systems (e.g., lane tracking system on a commercial motor vehicle). In medical monitoring, screening, diagnosis and treatment settings neurobehavioral assessment may be made based on physician or medical-care-provider observation or standard instruments used in the field such as (without limitation) the Mini-Mental State Examination (MMSE), the Mini-Cog Test, the Alzheimer's Disease Assessment Scale-cognitive (ADAS-cog), Ammons Quick Test, National Adult Reading Test (NART), Wechsler Adult Intelligence Scale (WAIS), Wechsler Intelligence Scale for Children (WISC), Wechsler Preschool and Primary Scale of Intelligence (WPPSI), Wechsler Test of Adult Reading (WTAR), California Verbal Learning Test, Cambridge Prospective Memory Test (CAMPROMPT), Doors and People, Memory Assessment Scales (MAS), Rey Auditory Verbal Learning, Test Rivermead Behavioral Memory Test, Test of Memory and Learning (TOMAL), Test of Memory Malingering (TOMM), Wechsler Memory Scale (WMS), Boston Diagnostic Aphasia Examination, Boston Naming Test, Comprehensive Aphasia Test, Lexical Decision Task, Multilingual Aphasia Examination, Behavioral Assessment of Dysexecutive Syndrome (BADS), CogSreen: Aeromedical Edition, Continuous Performance Task (CPT), Controlled Oral Word Association Test (COWAT), d2 Test of Attention, Delis-Kaplan Executive Function System (D-KEFS), Digit Vigilance Test Figural Fluency Test, Halstead Category Test, Halying and Brixton Tests, Iowa Gambling Test, Kaplan Baycrest Neurocognitive Assessment (KBNA), Kaufman Short Neuropsychological Assessment, Paced Auditory Serial Addition Test (PASAT), Pediatric Attention Disorders Diagnostic Screener (PADDS), Ruff Figural Fluency Test, Stroop Task, Test of Variables of Attention (TOVA), Tower of London Test, Trail Making Test (TMT), Trails A & B, Wisconsin Card Sorting task (WCST), Symbol Digit Modalities Test, Clock Test, Hooper Visual Organization Task (VOT), Rey-Osterrieth Complex Figure, Clinical Dementia Rating, Dementia Rating Scale, MCI Screen, Cambridge Neuropsychological Test Automated Battery (CANTB), The Neurobehavioral Cognitive Status Examination (Cognistat), Cognitive Assessment Screening Instrument, CNS Vital Signs (CNSVS), Cognitive Function Scanner (CFS), Dead-Woodcock Neuropsychology Assessment System (DWNAS), General Practitioner Assessment of Cognition (GPCOG), Hooper Visual Organization Test, Luria-Nebraska Neuropsychological Battery, A Developmental Neuropsychological Assessment (NEPSY), Repeatable Battery for the Assessment of Neuropsychological Status, CDR Computerized Assessment System, and/or the like. Furthermore, performance assessment on one or more neurobehavioral tasks may be measured by one or more standard tests including but not limited to: the Psychomotor Vigilance Test (PVT), the Motor Praxis Test (MPraxis), the Visual Object Learning Test (VOLT), the Fractal-2-Back Test (F2B), the Conditional Exclusion Task (CET), the Matrix Reasoning Task (MRsT), the Line Orientation Test (LOT), the Emotion Recognition Task (ER), the Balloon Analog Risk Task (BART), the Digit Symbol Substitution Test (DSST), the Forward Digit Span (FDS), the Reverse Digit Span (BDS), the Serial Addition and Subtraction Task (SAST), the Go/NoGo Task, the Word-Pair Memory Task, the Word Recall Test (Learning, Recall), the Motor Skill Learning Task, the Threat Detect Task, the Descending Subtraction Task (DST), the Positive Affect Negative Affect Scales-Extended version (PANAS-X) Questionnaire, the Pre-Sleep/Post-Sleep Questionnaires for astronauts, the Beck Depression Inventory (BDI), the Conflict Questionnaire, Karolinska Drowsiness Test (KDT), the Visual Analog Scales (VAS), the Karolinska Sleepiness Scale (KSS), the Profile of Mood States Long/Short Form Questionnaire (POMS/POMS SF), the Stroop Test, and/or the like.

### Methods to Test Fatigue Specifically

Although the presently disclosed invention may be used generally to compare the neurobehavioral status of one population to that of another, particular embodiments are specifically directed to assessment and comparison of neurobehavioral deficits associated with fatigue. Embodiments of the presently disclosed invention may make use of one or more techniques for measuring or testing an individual's fatigue levels (referred to hereinafter as “fatigue-measurement techniques”). Particular embodiments of the invention are sufficiently adaptable to utilize many (if not all) of these known fatigue-measurement techniques. Non-limiting and non-mutually exclusive examples of suitable fatigue-measurement techniques which may be used in various embodiments of the invention include testing techniques which use: (i) objective reaction-time tasks, stimulus-response tests, and cognitive tasks such as the Psychomotor Vigilance Task (PVT) or variations thereof (Dinges, D. F. and Powell, J. W. “Microcomputer analyses of performance on a portable, simple visual RT task during sustained operations” Behavior Research Methods. Instruments. & Computers 17(6): 652-655, 1985) and/or a so-called digit symbol substitution test; (ii) subjective alertness, sleepiness, or fatigue measures based on questionnaires or scales such as (without limitation) the Stanford Sleepiness Scale, the Epworth Sleepiness Scale (Jons, M. W., “A new method for measuring daytime sleepiness—the Epworth sleepiness scale” Sleep 14 (6): 54-545, 1991), and the Karolinska Sleepiness Scale (Åkerstedt, T. and Gillberg, M. “Subjective and objective sleepiness in the active individual” International Journal of Neuroscience 52: 29-37, 1990); (iii) EEG measures and sleep-onset-tests including (without limitation) the Karolinska drowsiness test (Akerstedt, T. and Gillberg, M. “Subjective and objective sleepiness in the active individual” International Journal of Neuroscience 52: 29-37, 1990), Multiple Sleep Latency Test (MSLT) (Carskadon, M. W. et al., “Guidelines for the multiple sleep latency test—A standard measure of sleepiness” Sleep 9 (4): 519-524, 1986) and the Maintenance of Wakefulness Test (MWT) (Mitler, M. M., Gujavarty, K. S. and Browman, C. P., “Maintenance of Wakefulness Test: A polysomnographic technique for evaluating treatment efficacy in patients with excessive somnolence” Electroencephalographv and Clinical Neurophysiology 53:658-661, 1982); (iv) physiological measures such as (without limitation) tests based on blood pressure and heart rate changes, and tests relying on pupillography and/or electrodermal activity (Canisius, S. and Penzel, T., “Vigilance monitoring—review and practical aspects” Biomedizinische Technik 52(1): 77-82., 2007); (v) embedded performance measurement systems, devices, and processes such as (without limitation) devices that are used to measure a driver's performance in tracking the lane marker on the road (see, e.g., U.S. Pat. No. 6,894,606); and (vi) simulators that provide a virtual environment to measure specific task proficiency such as commercial airline flight simulators (Neri, D. F., Oyung, R. L., et al., “Controlled breaks as a fatigue countermeasure on the flight deck” Aviation Space and Environmental Medicine 73(7): 654-664, 2002); and/or (vii) the like. Particular embodiments of the invention may make use of any one or more of the fatigue-measurement techniques described in the aforementioned references or various combinations and/or equivalents thereof. All of the publications referred to in this paragraph are hereby incorporated by reference herein.

### Models for Predicting Neurobehavioral Performance

The presently disclosed invention is designed to utilize any biomathematical model designed generally to model any one or more of a human subject's neurobehavioral performance characteristics. Such biomathematical models are referred to herein as “neurobehavioral performance models.” Particular embodiments are specifically designed to utilize biomathematical models that model a human subject's fatigue state and/or fatigue-related neurobehavioral deficits levels. Such biomathematical models are referred to herein as “fatigue models.” As used herein, the terms “biomathematical model(s),” “neurobehavioral performance model(s),” and “fatigue model(s)” shall have the following relationship: fatigue models are a subset of neurobehavioral performance models (fatigue being one type of neurobehavioral performance), and neurobehavioral performance models are, in turn, a subset of biomathematical models.

Among the neurobehavioral performance models utilized by the presently disclosed invention, particular embodiments may utilize the so-called “two-process model” of sleep regulation developed by Borbely et al. in 1999. The Borbely two-process model posits the existence of two primary regulatory mechanisms: (i) a sleep/wake-related mechanism that builds up exponentially during the time that the subject is awake and declines exponentially during the time that the subject is asleep, and is called the “homeostatic process” or “process S;” and (ii) an oscillatory mechanism with a period of (nearly) 24 hours, called the “circadian process” or “process C.” Without wishing to be bound by theory, the circadian process has been demonstrated to be orchestrated by the suprachiasmatic nuclei of the hypothalamus. The neurobiology of the homeostatic process is only partially known and may involve multiple neuroanatomical structures. Total alertness at a given time y(t), which is one non-limiting example of neurobehavioral performance, may then be represented as a sum of the C and S processes (see Equation 3, below).

Further details related to the application of the Borbely two-process fatigue model are contained in PCT published patent application Systems and Methods for Individualized Alertness Predictions, inventors Mott C. G., Mollicone, D. J., et al., WIPO publication No. WO 2009/052633, the entirety of which is incorporated herein by reference and from which portions of the following discussion are excerpted for convenience and clarity. Specifically, in accordance with the two-process model, the circadian process C may be represented by:

$$C ( t ) = γ {\sum }_{l = 1}^{5} {a}_{l} sin ( 2 l π ( t - ϕ ) / τ ) \qquad ( 1 )$$

where t denotes clock time (in hours, e.g. relative to midnight), φ represents the circadian phase offset (i.e. the timing of the circadian process C relative to clock time), γ represents the circadian amplitude, and τ represents the circadian period which may be fixed at a value of approximately or exactly 24 hours. The summation over the index/serves to allow for harmonics in the sinusoidal shape of the circadian process. For one particular application of the two-process model for alertness prediction, l has been taken to vary from 1 to 5, with constants a₁ being fixed at a₁=0.97, a₂=0.22, a₃=0.07, a₄=0.03, and a₅=0.001.

The homeostatic process S may be represented by:

$$S ( t ) = \{ \begin{matrix}{e}^{- {ρ}_{w} Δ t} {S}_{t - Δ t} + ( 1 - {e}^{- {ρ}_{w} Δ t} ) & if during wakefulness \\ {e}^{- {ρ}_{w} Δ t} {S}_{t - Δ t} & if during sleep\end{matrix} \qquad \begin{matrix}( 2 a ) \\ ( 2 b )\end{matrix}$$

(S>0), where t denotes (cumulative) clock time, Δt represents the duration of time step from a previously calculated value of S, ρ_{w} represents the time constant for the build-up of the homeostatic process during wakefulness, and ρₛ represents the time constant for the recovery of the homeostatic process during sleep.

Given equations (1), (2a) and (2b), the total alertness according to the two-process model may be expressed as a sum of: the circadian process C, the homeostatic process S multiplied by a scaling factor κ, and an added noise component ε(t):

y(t)=KS(t)+C(t)+ε(t) (3)

Furthermore, it is useful to be able to describe the homeostatic process S for test subject after one or more transitions between being asleep and being awake. The sleep-wake transitions are commonly (but without limitation) represented as square wave signals oscillating between the binary states of being asleep (value=1 herein, without limitation) and being awake (value=0 herein, without limitation), referred to as sleep functions. Other mathematical representations of sleep status and effectiveness can be utilized by the presently disclosed invention.

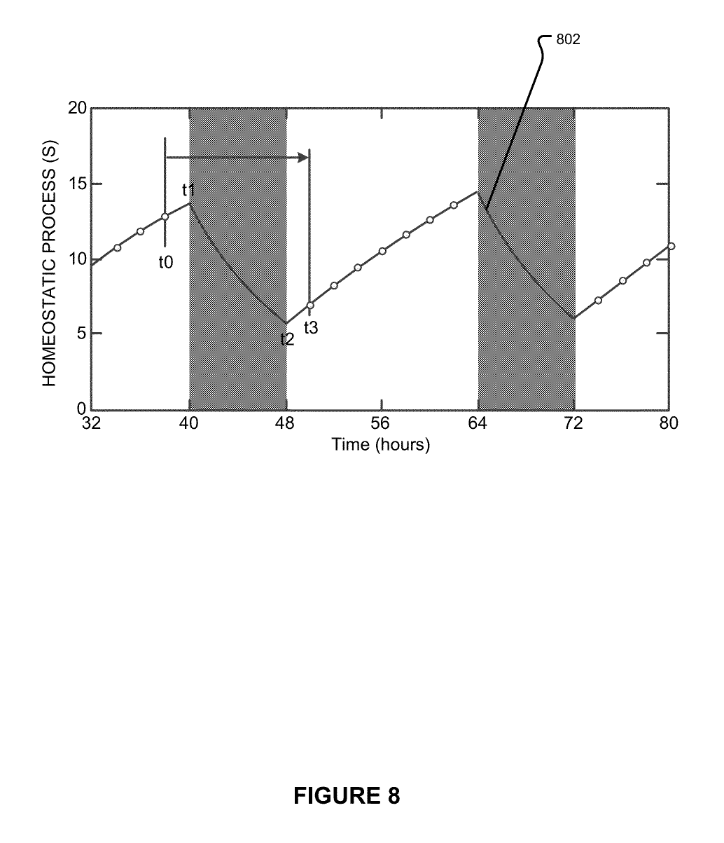

As described in more particular detail below, the systems and methods of the invention may make use of measured neurobehavioral performance levels that are typically only available when the subject is awake. Consequently, it may be desirable to describe the homeostatic process between successive periods that the test subject is awake. As the circadian process C is independent from the homeostatic process 5, we may consider as an illustrative case of neurobehavioral performance using only the homeostatic process S of equations (2a), (2b). Consider the period between t₀ and t₃ shown in FIG. 8. During this period, the subject undergoes a transition from awake to asleep at time t₁ and a transition from asleep to awake at time t₂. Applying the homeostatic equations (2a), (2b) to the individual segments of the period between t₀ and t₃ yields:

S(t₁)=S(t₀)e^{-p}^{ₑ}^{T}^{₁}+(1−e^{-p}^{ₑ}^{T}^{₁}) (4a)

S(t₂)=S(t₁)e^{-p}^{ₑ}^{T}^{₂} (4b)

S(t₃)=S(t₂)e^{-p}^{ₑ}^{T}^{₃}+(1−e^{-p}^{ₑ}^{T}^{₃}) (4c)

where

T₁=t₁−t₀ (5a)

T₂=t₂−t₁ (5b)

T₃=t₃−t₂ (5c)

Substituting equation (5a) into (5b) and then (5b) into (5c) yields an equation for the homeostat at a time t₃ as a function of an initial known homeostat condition S(t₀), the time constants of the homeostatic equations (ρ_{w}, ρₛ) and the transition durations (T₁, T₂, T₃):

$$\begin{matrix}S ( {t}_{3} ) = fs ( S ( {t}_{0} ) , {ρ}_{w} , {ρ}_{s} , {T}_{1} , {T}_{2} , {T}_{3} ) \\ = [ S ( {t}_{0} ) {e}^{- {ρ}_{w} {T}_{1}} + ( 1 - {e}^{- {ρ}_{w} {T}_{1}} ) ] {e}^{- {ρ}_{s} {T}_{2} - {ρ}_{w} {T}_{3}} + ( 1 - {e}^{- {ρ}_{w} {T}_{3}} )\end{matrix} \qquad ( 6 )$$

Equation (6) applies to the circumstance where t₀ occurs during a period when the test subject is awake, there is a single transition between awake and asleep at t₁ (where t₀<t₁<t₃), there is a single transition between asleep and awake at t₂ (where t₁<t₂<t₃), and then t₃ occurs after the test subject is awake again.

Additional fatigue models may be utilized by particular embodiments. Other non-limiting examples of fatigue models include Akerstedt's “three-process model of alertness” (see, e.g., Akerstadt, T., et al. “Predictions from the Three-Process Model of Alertness,” Aviation, Space, and Environmental Medicine, 75:No. 3, §II (March 2004); see also Akerstedt, T. et al. “A Model of Human Sleepiness,” excerpted from Sleep '90 J. Horne, Ed. (Pontenagel Press 1990)); Achermann's “two-process model revisited” (see e.g., Achermann, P., “The Two-Process Model of Sleep Regulation Revisited,” Aviation, Space, and Environmental Medicine, 75:No. 3, §II (March 2004)); Avinash's “process-U model” (see Avinash, D., “Parameter Estimation for a Biomathematical Model of Psychomotor Vigilance Performance under Laboratory Conditions of Chronic Sleep,” Sleep-Wake Research in the Netherlands 16:39-42 (Dutch Society for Sleep-Wake Research 2005); Beersma's “modified two-process model” (see, e.g., Beersma, D. G. M., “Models of Human Sleep Regulation,” Sleep Medicine Reviews 2:No. 1, pp. 31-43 (W.B. Saunders Co. Ltd. 1998)); Belyavin and Spencer's “QinetiQ Approach” (see, e.g., Belyavin, A. J. and Spencer, M. B., “Modeling Performance and Alertness: the QinetiQ Approach,” Aviation, Space, and Environmental Medicine, 75:No. 3, §II (March 2004)); the “circadian alertness simulator” (see, e.g., Dijk, D. J., et al. “Fatigue and Performance Models: General Background and Commentary on the Circadian Alertness Simulator for Fatigue Risk Assessment in Transportation,” Aviation, Space, and Environmental Medicine, 75:No. 3, §II (March 2004)); the so-called “new model class” (see, e.g., McCauley, P., et al, “A new mathematical model for the homeostatic effects of sleep loss on neurobehavioral performance,” Journal of Theoretical Biology, 256:227-239 (Reed-Elsevier 2009)); alternative models such as nonparametric approaches and neural networks (see, e.g., Reifman, J., “Alternative Methods for Modeling Fatigue and Performance,” Aviation, Space, and Environmental Medicine, 75:No. 3, §II (March 2004)); and/or the like. Particular embodiments of the presently disclosed invention may make use of any one or more of the biomathematical models described in the aforementioned references or various combinations and/or equivalents thereof. All of the publications referred to in this paragraph are hereby incorporated by reference herein.

The presently disclosed invention may utilize one or more of the foregoing biomathematical models to predict neurobehavioral performance levels when certain inputs are provided. Particular embodiments may focus on fatigue as the specific type of neurobehavioral status being measured and/or assessed.

Embodiments of the invention use fatigue models and/or their model parameters to estimate trait values for fatigue-related individual traits which may not be directly measurable or observable. As used in this description and the accompanying claims, the word “trait” is used to refer to a characteristic of a particular individual subject that have enduring (i.e. relatively non-time-varying) values for the individual subject. Traits differ as between individual subjects. Non-limiting examples of fatigue-related individual traits for a subject include: whether the subject is alert on a minimum amount of sleep; whether the subject is a “night owl” (i.e. relatively more alert late at night) or a “morning person” (i.e. relatively more alert in the early morning); the rate of fatigue level increase for the subject during wakefulness (e.g. the rate of homeostatic buildup (ρ_{w})); the rate of fatigue level reduction for the subject during sleep (e.g. the rate of homeostatic recovery (ρₛ); the extent to which time of day (circadian rhythm) influences alertness for the subject (e.g. circadian amplitude (γ)); aptitude for specific performance tasks for the subject; other traits for the subject described in Van Dongen et al., 2005 (Van Dongen et al., “Individual difference in adult human sleep and wakefulness: Leitmotif for a research agenda.” Sleep 28 (4): 479-496, 2005), which are hereby incorporated herein by reference.

An individual's traits may be contrasted with the individual's “states”. As used in this description and the accompanying claims, the word “state” is used to describe characteristics of a particular individual which vary with time and which may one or more circumstances or external conditions (e.g. sleep history, light exposure, etc.). Non-limiting examples of individual states of a subject include: the amount of sleep that the subject had in the immediately preceding day(s); the level of homeostatic process of the subject at the present time; the circadian phase of the subject (Czeisler, C., Dijk, D, Duffy, J., “Entrained phase of the circadian pacemaker serves to stabilize alertness and performance throughout the habitual waking day,” Sleep Onset: Normal and Abnormal Processes, pp. 89-110, 1994 (“Czeisler, C. et al.”)); the current value of light response sensitivity in the circadian process (Czeisler, C., Dijk, D, Duffy, J., “Entrained phase of the circadian pacemaker serves to stabilize alertness and performance throughout the habitual waking day,” pp. 89-110, 1994); the levels of hormones for the subject such as cortisol, or melatonin, etc. (Vgontzas, A. N., Zoumakis, E., et al., “Adverse effects of modest sleep restriction on sleepiness, performance, and inflammatory cytokines.” Journal of Clinical Endocrinology and Metabolism 89(5): 2119-2126, 2004); the levels of pharmacological agent(s) for the subject known to affect alertness such as caffeine, or Modafinil (Kamimori, G. H., Johnson, D., et al., “Multiple caffeine doses maintain vigilance during early morning operations.” Aviation Space and Environmental Medicine 76(11): 1046-1030, 2005). The references referred to in this paragraph are hereby incorporated herein by reference.

In this description and the accompanying claims, the term “individual” (or “subject,” used synonymously) is used to refer a person from whom neurobehavioral performance data is collected and concerning whom a comparison of a neurobehavioral status to some other individual or population is sought. (As used herein populations may comprise single individuals.) Conversely, in this description and the accompanying claims, the term “user” is used to refer to a person from whom data is collected for whom the outputted comparison of neurobehavioral statuses between two populations is determined. “User” may refer to a person or organization that may be supervising the operation of the methods and systems described herein and that may make use of the compared neurobehavioral statuses about the subject individual(s) or population(s). By way of non-limiting example: users may comprise corporate or sole employers who may have an interest in monitoring, educating or improving the performance of subjects who may be employees; users may comprise military officers or commanders who may have an interest in overseeing military units which may include groups of subjects; users may include one or more researchers who may want to collect research data to test populations of subjects; and/or the like.

In this description and the accompanying claims, the term “population” is used to refer to a set of individuals (typically, although not exclusively, a set human beings) from whom data is collected and about whom the neurobehavioral profile is tailored. A used in this description and the accompanying claims, a “population” may comprise a single individual, or it may comprise no individuals (i.e., is the “null set”).

### The Figures

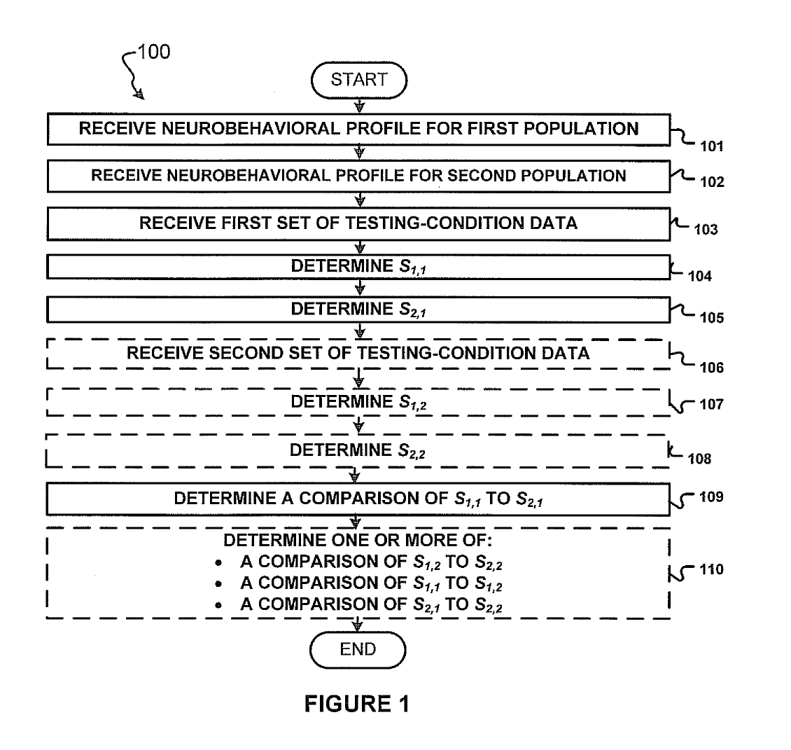

FIG. 1 provides a flowchart for method 100 used to determine the comparison 1000 of the neurobehavioral status of a first population 802 to the neurobehavioral status of a second population 902, in accordance with particular non-limiting embodiments. Method 100 commences in steps 101 and 102, wherein a first neurobehavioral profile 801 and a second neurobehavioral profile 901 are received, respectively. First neurobehavioral profile 801 is capable of indicating a neurobehavioral status of the first population 802 when matched to a set of testing conditions. According to particular non-limiting embodiments, first population 802 may comprise an experimental population. Second neurobehavioral profile 901 is also capable of indicating a neurobehavioral status of the second population 902 when matched to a set of testing conditions. According to particular non-limiting embodiments, second population 902 may comprise a control population. According to particular embodiments populations 802, 902 are arbitrary populations. According to particular embodiments populations 802, 902 may comprise one or more of a workforce, a military unit, a plurality of individuals with shared demographics, a plurality of individuals with one or more shared medical conditions, and/or the like. In this description and the accompanying claims, the term “population” may comprise a single individual or may be empty (i.e., comprising the null set). According to particular embodiments populations 802, 902 may each comprise single individuals, may both comprise the same individual, and may either or both comprise the null set. Furthermore, according to some embodiments, first population 802 may comprise a member of second population 902, and according to other embodiments second population 902 may comprise a member of first population 802. According to particular embodiments, more than two populations (up to an arbitrary number N) may be used for comparison purposes through repeated application of the methods disclosed herein in appropriate combinations.

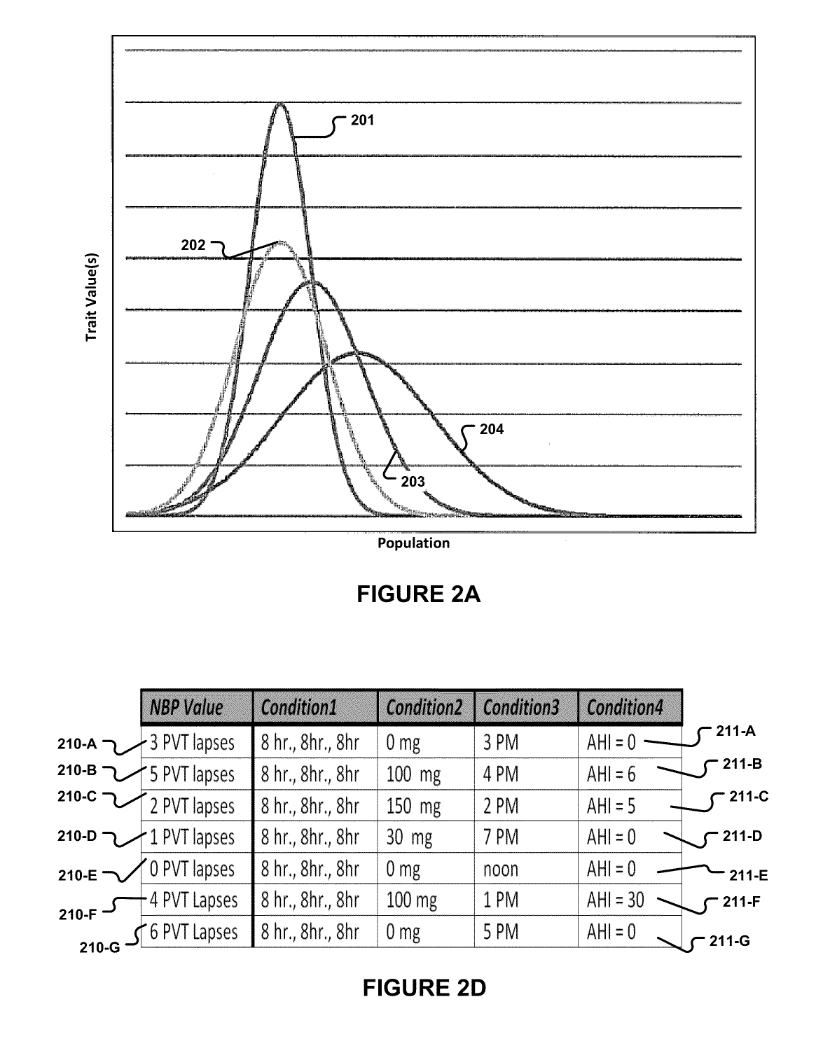

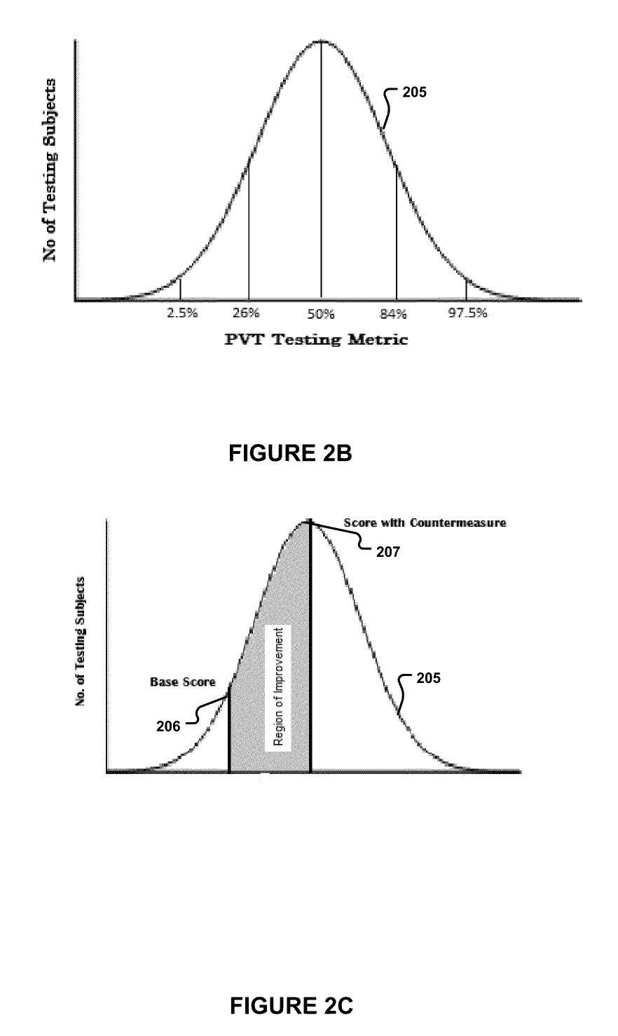

In this description and the accompanying claims, the term “neurobehavioral profile” is used to refer to either a set of one or more neurobehavioral trait values corresponding to a population (see, e.g., FIG. 2A and surrounding discussion) or a set of one or more neurobehavioral performance values each corresponding to particular testing conditions (see, e.g., FIG. 2D and surrounding discussion). A neurobehavioral profile, such as first neurobehavioral profile 801 and second neurobehavioral profile 901, may be created by the collection of multiple neurobehavioral performance assessments across a wide range of (testing) conditions. In particular embodiments, the neurobehavioral profile consists simply of the neurobehavioral performance values and matching external conditions. Such embodiments may take the form of a list, a database, an array, a table, a look-up table, a hashtable, and/or the like. In other embodiments, neurobehavioral profiles 801, 901 are created through the aforementioned collection of neurobehavioral performance data but also comprise applying a neurobehavioral performance model to the data to determine values for the set of one or more neurobehavioral traits that comprise the profile. In such embodiments, the trait values themselves comprise the profile, and neurobehavioral performance can be estimated using the traits by applying a neurobehavioral performance under an assumed or provided set of conditions. In particular embodiments, collection of neurobehavioral performance data may occur across a sufficiently diverse set of conditions such that the profile is not biased toward a particular set of conditions. In other embodiments, such condition biases may be created through the careful selection of neurobehavioral performance data associated with particular conditions. (Further details regarding testing conditions are provided, below, in connection with the discussion of step 103 of method 100A.) In other embodiments neurobehavioral profiles 801, 901 may be created through the aggregation of measured neurobehavioral status measurements (or performance measurements) under known testing conditions.

According to some embodiments, particular trait-based neurobehavioral profiles may be model dependent—i.e., the set of one or more neurobehavioral traits that comprise a neurobehavioral profile are commonly (though not necessarily) tied to a specific neurobehavioral performance model. Particular embodiments utilize neurobehavioral profiles that depend upon the two-state model of fatigue prediction (see, e.g., Borbley 1999). Of the embodiments that utilize neurobehavioral profiles that depend upon the two-state model of fatigue predictions, some embodiments utilize sets of neurobehavioral traits that comprise one or more of: circadian phase offset φ, circadian phase amplitude γ, circadian period τ, one or more Fourier constants a₁ for harmonics in the sinusoidal shape of the circadian process, the time constant ρ_{w} for the rate of homeostatic buildup during wakefulness, the time constant ρₛ for the rate of homeostatic recovery during sleep, the arbitrary scaling factor κ, a noise coefficient ε or function ε(t), and/or the like. Other embodiments may utilize neurobehavioral profiles that depend upon one or more of the three-process model of alertness, the two-process model revisited, the process-U model, the modified two-process model, the QinetiQ approach, the circadian alertness simulator, alternative models such as nonparametric approaches and neural networks, and/or the like. The presently disclosed invention may utilize neurobehavioral profiles that depend upon any neurobehavioral performance models known in the art and that are comprised of sets of any neurobehavioral traits known in the art.

The multiple views of FIG. 2 illustrate (non-limiting) exemplary embodiments of neurobehavioral profiles according to the presently disclosed invention. FIG. 2A, for example, illustrates a neurobehavioral profile comprising four (4) distributions of distinct neurobehavioral trait values 201, 202, 203, 204 as exhibited in a hypothetical population. Trait-value distributions 201, 202, 203, 204 may be distributions of any neurobehavioral trait known in the art and may optionally be associated with any one or more neurobehavioral performance models known in the art. In particular embodiments (not shown), a neurobehavioral profile of the variety shown in FIG. 2A may be constructed for an individual instead of a plurality of individuals comprising a population. In such embodiments, the neurobehavioral profile will not comprise distributions of trait values, but rather single values for each trait (with optional error ranges, error bars, and/or error distributions according to the measurement and data-collection techniques used to gather the trait values).

To determine a neurobehavioral status using a neurobehavioral profile of the variety illustrated in FIG. 2A, one must specify a set of testing conditions and then supply a neurobehavioral performance model. Applying the model to the traits and testing conditions will then result in a neurobehavioral performance estimate.

Distributions 201, 202, 203, 204 are illustrated as near perfect normal distributions by way of example, but this idealized condition need not be the case for all embodiments. In the case of neurobehavioral profiles comprising large data sets of neurobehavioral traits (e.g., a large number of performance assessments conducted on a large number of individuals within a population), idealized normal distributions may be expected, but when data sets on neurobehavioral traits are smaller (e.g., fewer assessments on only a small number of individuals), deviations from perfect normalized distributions may occur. Furthermore a neurobehavioral profile according to the presently disclosed invention may comprise an arbitrary number of distributions of neurobehavioral traits for the corresponding population.

FIG. 2D comprises a table or array of neurobehavioral performance values 210-A through 210-G, each corresponding to a set of known testing conditions, 211-A through 211-G, respectively. (Testing conditions 211-A through 211-G comprise four fields of data each, corresponding to the respective data fields labeled “Condition1,” “Condition2,” “Condition3,” and “Condition4.”) According to particular embodiments, the neurobehavioral performance values 210-A through 210-G are neurobehavioral performance values that were actually measured with respect to testing subject 110 when the known testing conditions 211-A through 211-G were present, respectively. In the hypothetical neurobehavioral profile of FIG. 2D, the neurobehavioral performance values indicated are the number of lapses in a 3-minute PVT, and the testing conditions 211-A through 211-G illustrated comprise prior 3-day sleep history (Condition1), amount of caffeine ingested in past three (3) hours (Condition2), the time at which the test was administered (Condition3), and the severity of a common medical condition (Condition4). (“AH1” represents the apnea-hypopnea index for individuals suffering from sleep apnea or other sleep-disordered breathing condition, measured as the number of cessations in breathing lasting ten seconds or longer per one hour of sleep.)

To determine a neurobehavioral status using a neurobehavioral profile of the variety illustrated in FIG. 2D, one may specify a set of testing conditions and then search for the specified testing conditions within the one or more set of testing conditions comprising the profile and return the neurobehavioral performance associated therewith. Various search algorithms may be implanted to accomplish this task. By way of example, a search algorithm may comprise first calculating a numeric distance function between the specified testing condition and another test condition based on a weighted sum of the absolute difference between corresponding test condition values, then determining the testing condition that has the lowest numeric distance to the specified testing condition.

FIG. 2B provides another example of a neurobehavioral profile (of the FIG. 2A variety) according to the present invention, namely, a single-trait profile comprising a solitary distribution for a PVT metric (e.g., number of lapses, mean reaction time, fastest ten-percent reaction time, etc.) across a hypothetical population. The PVT metric may optionally be associated with one or more neurobehavioral performance models known in the art according to some embodiments. According to other embodiments, the PVT metric may be associated with the two-state model of alertness prediction.

Method 100 continues in step 103, in which a first set of testing-condition data 805 is received. First set of testing-condition data 805 reflects a particular set of testing conditions 804 under which a neurobehavioral status of first population 802 is desired for comparison purposes. The first set of testing conditions 804 may also be associated with a first time of interest for when the neurobehavioral status of the first population 802 may be desired. A first time of interest may comprise one or more of: reporting for work, reporting for military duty, undergoing medical examination, undergoing medical treatment, driving a vehicle, operating machinery, physical activity, athletic competition, enrolling in the military from civilian life, resuming civilian life after military duty, engaging in a task with an associated neurobehavioral or fatigue risk, and/or the like.

In this description and the accompanying claims, the term “testing condition” (used synonymously with “external condition” or simply “condition,”) is used to refer to one or more variables, factors, conditions, or inputs that may impact the measurement of a subject's neurobehavioral performance (other than the neurobehavioral status itself) during a neurobehavioral performance assessment. Such variables may be analyzed into the following non-limiting list of categories: sleep and work history (comprising any factors related to an individual's or a populations sleep and work states), so-called “external factors” (relating to environmental conditions that may affect results of neurobehavioral performance assessments), dosing or application of neurobehavioral countermeasures (such as stimulants and additional sleep), and presence of neurobehavioral stressors (specific factors known to impact neurobehavioral performance). Specific types of data within each category include the following non-limiting list of examples: i) sleep and work history: actigraphy, a sleep schedule, one or more sleep onset times, one or more sleep interval durations, a duration of total time in bed over an extended period, a work schedule, one or more work shift identifiers, one or more work start times, one or more work interval durations, and a duration of total work time over an extended interval; ii) external factors: weather data, environmental data, and noise or sound data; iii) dosing or application of neurobehavioral countermeasures: a schedule of stimulant ingestion, a sleep schedule, a schedule of physical activity, and an exercise schedule; and iv) existence of neurobehavioral stressors: prolonged wakefulness, circadian misalignment, extended time on duty, and night work.

Method 100 continues in step 104, in which a neurobehavioral status 806-1 of the first population 802 corresponding to the first set of testing conditions is determined. Neurobehavioral status 806-1 corresponds to the neurobehavioral status of first population 802 as would be exhibited under the first set of testing conditions 804 indicated by the step-103 received first set of testing-condition data 805. Neurobehavioral status 806-1 is determined either by applying a neurobehavioral performance model to the neurobehavioral trait parameters identified in first neurobehavioral profile 801 subject to the first set of target testing conditions 804 or by locating in the neurobehavioral profile 801 the neurobehavioral performance values associated with the testing conditions indicated by the step-103 received set of testing-condition data. In particular embodiments, the neurobehavioral performance model used to determine the first neurobehavioral status 806-1 is the same neurobehavioral performance model associated with the first neurobehavioral profile 801. In other embodiments, different neurobehavioral performance models may be used.

By way of non-limiting example, FIG. 2C illustrates how the single-trait profile of FIG. 2B may be used along with a step-103 received first set of testing-condition data 805 to determine a step-104 determined neurobehavioral status 806-1, in accordance with particular embodiments. The neurobehavioral profile of FIGS. 2B and 2C comprises a solitary distribution of a PVT metric across a hypothetical population. Two PVT scores are identified for a specific individual in FIG. 2C. Score 206 corresponds to the individual's base score (e.g., the PVT score he or she received upon being tested while reporting for work or military duty). Score 207 corresponds to the individual's predicted score. The predicted score, according to particular embodiments, corresponds to the score the individual (or population) might expect to receive if tested under a different set of external conditions. Score 207 is predicted by a neurobehavioral performance model associated with the neurobehavioral profile of FIGS. 2B and 2C in light of step-103 received first set of testing-condition data 805.

Method 100 continues in step 105, in which a neurobehavioral status 806-2 is determined for second population 902. Neurobehavioral status 806-2 corresponds to the neurobehavioral status of the second population 902 as would be exhibited under the first set of testing conditions 804 indicated by the step-103 received first set of testing-condition data 805. Neurobehavioral status 806-2 is analogous in all ways to neurobehavioral status 806-1, except that neurobehavioral status 806-2 pertains to the second population 901.

Method 100 may continue in optional step 106, in which a second set of testing-condition data 905 is received. Second set of testing-condition data 905 reflects a particular second set of testing conditions 904 under which a neurobehavioral status of either the first population 801 or the second population 901 may be desired for comparison purposes. Second set of testing conditions 904 may be associated with a second time of interest in a fashion similar to that of the first set of testing conditions 804 discussed in connection with step 103. Second time of interest may comprise any one or more of the stated times discussed therewith. Second time of interest may optionally be the same time or a comparable time to the first time of interest, in accordance with particular embodiments.

Method 100 may then continue in optional step 107, in which a neurobehavioral status 906-1 is determined for first population 802. Neurobehavioral status 906-1 corresponds to the neurobehavioral status of first population 802 as would be exhibited under the second set of testing conditions 904 indicated by the optional step-105 received second set of test-condition data 905. Neurobehavioral status 906-1 is determined in an analogous fashion (and is in all ways otherwise analogous) to neurobehavioral status 806-1, except that neurobehavioral status 906-1 pertains to the step-106 received set of second testing-condition data 905.

Method 100 may then continue in optional step 108, in which a neurobehavioral status 906-2 is determined for second population 902. Neurobehavioral status 906-2 corresponds to the neurobehavioral status of second population 902 as would be exhibited under the second set of testing conditions 904 indicated by the optional step-105 received second set of test-condition data 905. Neurobehavioral status 906-2 is determined in an analogous fashion (and is in all ways otherwise analogous) to neurobehavioral status 806-2, except that neurobehavioral status 906-1 pertains to the step-106 received set of second testing-condition data 905.

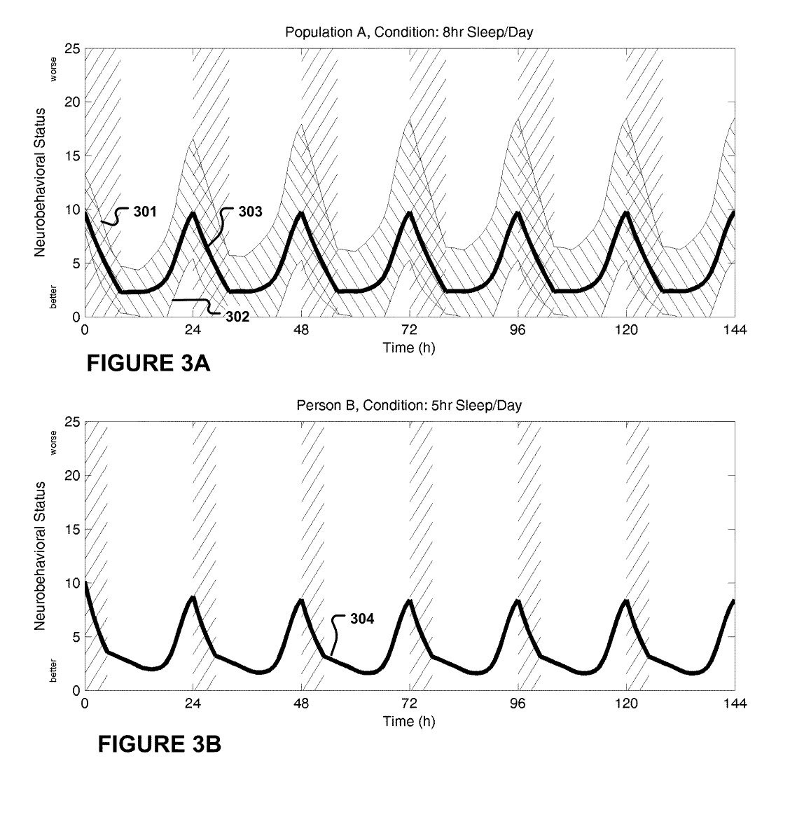

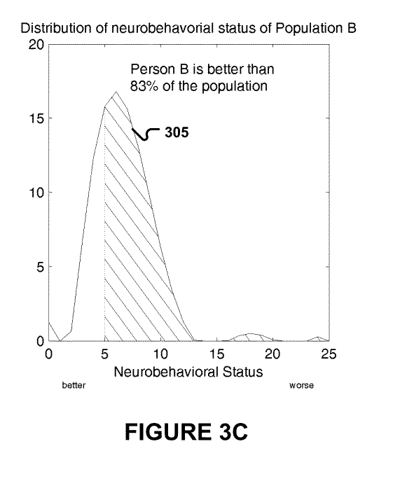

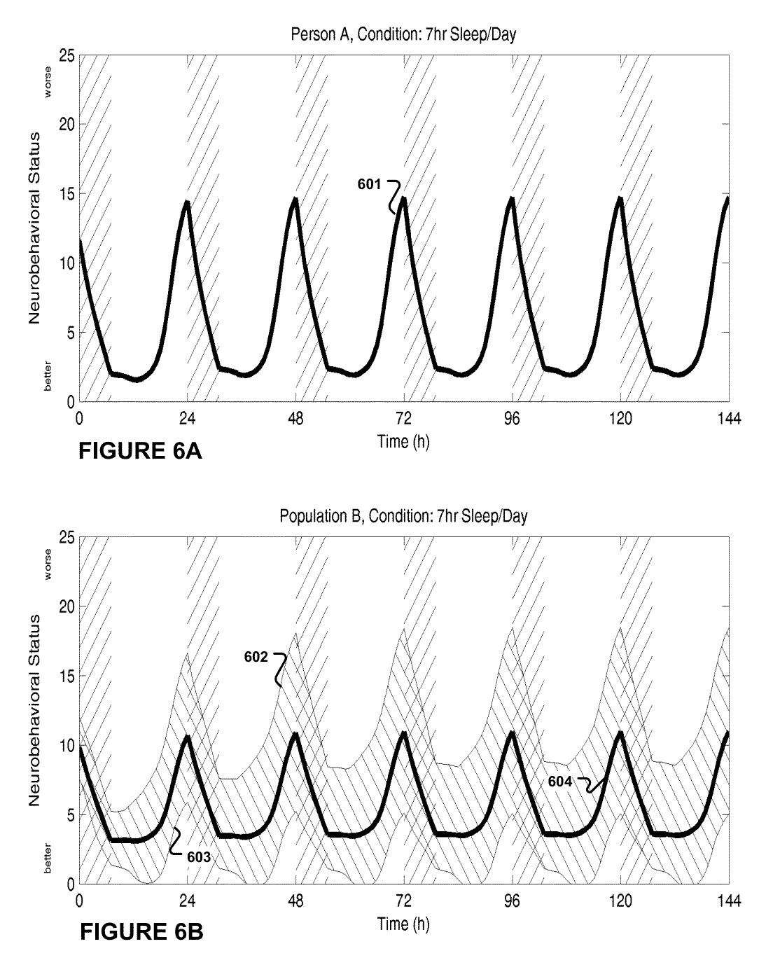

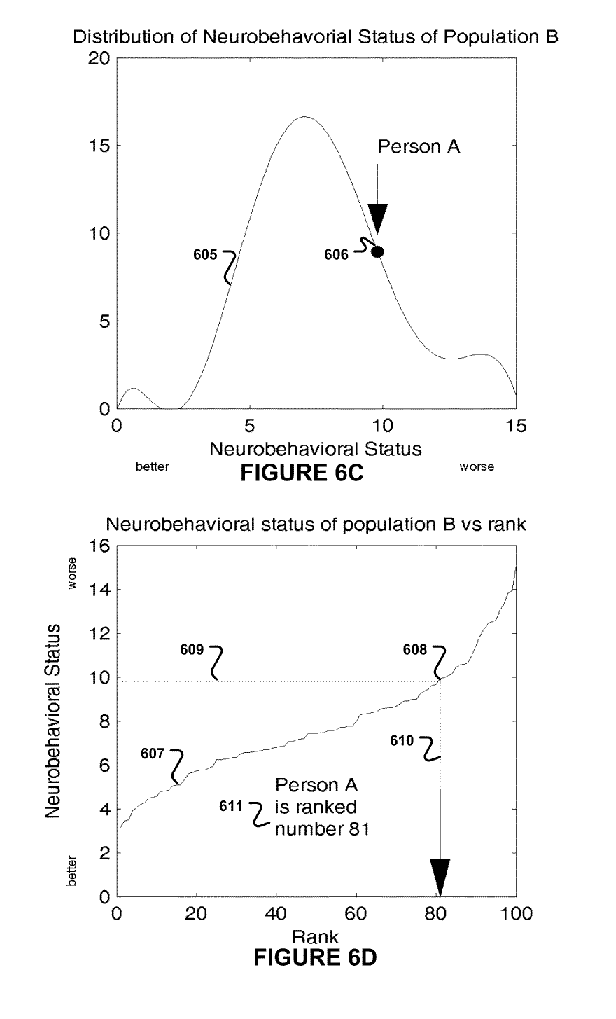

Method 100 continues in step 109, in which a comparison 1000 of the neurobehavioral status 806-1 of the first population 802 associated with the first set of testing conditions 804 is determined with respect to the neurobehavioral status 806-2 of the second population 902 associated with the first set of testing conditions 804. A step-109 comparison 1000 may take any of several forms, as discussed below in connection with the multiple views of FIG. 3 through the multiple views of FIG. 6. For the introductory sample case of FIG. 2C, one particular step-107 determined comparison 1000 may comprise the “region of improvement” between the base score 206 and the predicted score 207, which may be represented as one or more of a difference in scores, a difference in numerical rank among the population, a difference in percentile raking among the population, a percentage change, whether a threshold score (not shown) was exceeded, and/or the like.

Method 100 may also continue with optional step 110 in which case additional comparisons 1010 may be determined. According to particular embodiments additional comparisons 1010 may involve comparing neurobehavioral status of either the first population 802 or the second population 902 across different sets of testing conditions 804, 904. According to other embodiments, additional comparisons 1010 may involve comparing the neurobehavioral status of the first population to the neurobehavioral status of the second population, but in accordance with the second set of testing conditions.

In particular embodiments, method 100 is executed a single time and in the order of steps presented, although such restrictions are not an essential component of the present invention. In other embodiments one or more steps may be repeated, or the steps may be executed out of order. In particular embodiments, steps 103 (receive first set of testing conditions 84), 104 (determine first neurobehavioral status 806), and 107 (determine comparison 1000) may be repeated an arbitrary number of times so that a plurality of comparisons 1000 may be determined in step 108 for a plurality of different first sets of testing-condition data 805. Additionally, in particular embodiments, steps 102 (receive second neurobehavioral profile), 103, 104, and 107 may be repeated a plurality of times so that a plurality of comparisons 1000 may be determined in step 108 for different second populations 902. Similarly, any sequence of steps in method 100 may be repeated so as to create a plurality of comparisons 1000 in step 108 that leads to similar comparisons with one or more variables, data sets, or inputs changed.

The multiple views of FIG. 3 provide non-limiting examples of step-107 determined comparisons 1000 of the neurobehavioral status 806 of the first population 802 to the neurobehavioral status 906 of the second population 902, in accordance with particular embodiments, wherein the second population 902 comprises an individual. Specifically, FIG. 3A provides a multi-day chart illustrating the neurobehavioral status (e.g., fatigue state) of a first population 802. The neurobehavioral status of first population 802 is illustrated as a set of three (3) distinct neurobehavioral status graphs 301, 302, 303. Neurobehavioral status graphs 301 and 302 represent the “outer boundaries” (i.e., performance assessment scores of the highest and the lowest scoring individuals within the population) of the neurobehavioral status of first population 802 over the time frame indicated. Neurobehavioral status graph 303 represents an average or mean neurobehavioral performance of first population 802.

FIG. 3B provides a corresponding multi-day chart for second population 902, wherein second population 902 comprises an individual. Neurobehavioral status graph 304 therefore represents the neurobehavioral status of the individual comprising second population 902 over the time frame indicated. It must be noted that for a proper comparison 1000 of the first determined neurobehavioral status 806 to the second neurobehavioral status 906 to be conducted in step 107 of method 100, the difference in sleep history conditions between first population 802 (8 hours per day) and second population 902 (5 hours per day) must be accounted for. This can be accomplished by appropriate selection of one or more of the first or second received sets of testing-condition data 805, 905 in steps 103 and 106 of method 100, respectively. This could be accomplished by setting the received set of first testing-condition data 805 to include a 5-hour sleep schedule in step 103, or it could be accomplished by setting the optional received set of second testing condition data 905 to include an 8-hour sleep schedule in optional step 105. The neurobehavioral performance model associated with the received first and second neurobehavioral profiles 801, 901 would be able to convert neurobehavioral performance and/or neurobehavioral status values from one sleep schedule to the other.

Regarding respective neurobehavioral statuses 806, 906 of populations 802 and 902, FIG. 3C provides one non-limiting way in which to determine the comparison 1000 in step 107 of method 100. Graph 305 is a histogram of the neurobehavioral status of all members of first population 802. Boundary 306 represents the neurobehavioral status of the individual comprising second population 902. A display report might be given in which a percentage ranking is shown (e.g., “The individual 902 is better off than 90% of the population 802.”). Other non-limiting examples of comparisons 1000 between first and second populations 802 and 902, wherein second population 902 comprises an individual include: a percentile raking of the individual with respect to the second population, a numerical ranking of the individual with respect to the second population, a percentage of the second population with neurobehavioral response above or below the neurobehavioral status of the individual, the number of members of the second population with neurobehavioral status above or below the neurobehavioral response of the individual, and/or the like.

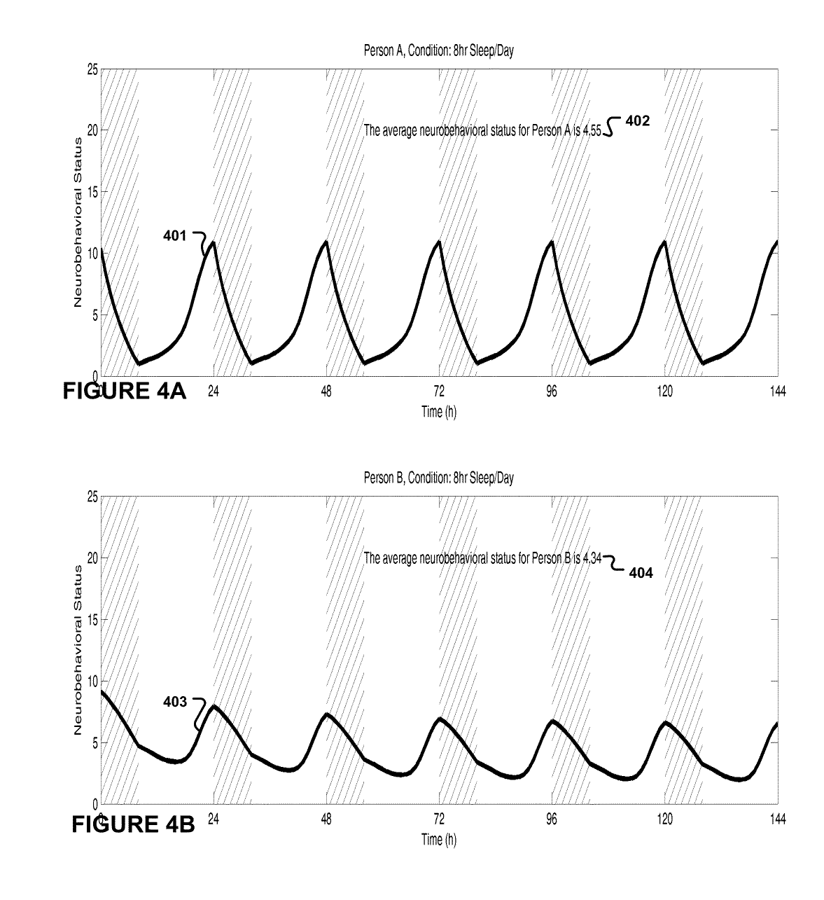

The multiple views of FIG. 4 provide non-limiting examples of step-107 determined comparisons 1000 of the neurobehavioral status 806 of the first population 802 to the neurobehavioral status 906 of the second population 902, in accordance with particular embodiments, wherein the both the first and the second population 902 comprise individuals (whether the same or different individuals). Specifically, FIG. 4A provides a multi-day chart illustrating the neurobehavioral performance (e.g., fatigue state) of a first population 802 comprising an individual. An overall neurobehavioral status 402 corresponding to the entire time interval of interest (i.e., an average neurobehavioral status value of 4.55) is also shown.

FIG. 4B provides a multi-day chart illustrating the neurobehavioral performance 403 of a second population 902. An overall neurobehavioral performance status 404 corresponding to the time interval of interest (e.g., an average neurobehavioral status value of 4.34) is also shown. Non-limiting examples of comparisons 1000 between the neurobehavioral statuses 806, 906 of first and second populations 802 and 902, wherein both first and second populations 802, 902 comprise an individual include: a difference in neurobehavioral status under differing first and second set of testing conditions, a difference in neurobehavioral status under differing first and second time periods of interest, a percentage change in neurobehavioral status under differing first and second set of testing conditions, a percentage change in neurobehavioral status under differing first and second time periods of interest, a recommended countermeasure to improve neurobehavioral performance to a particular threshold, and/or the like.

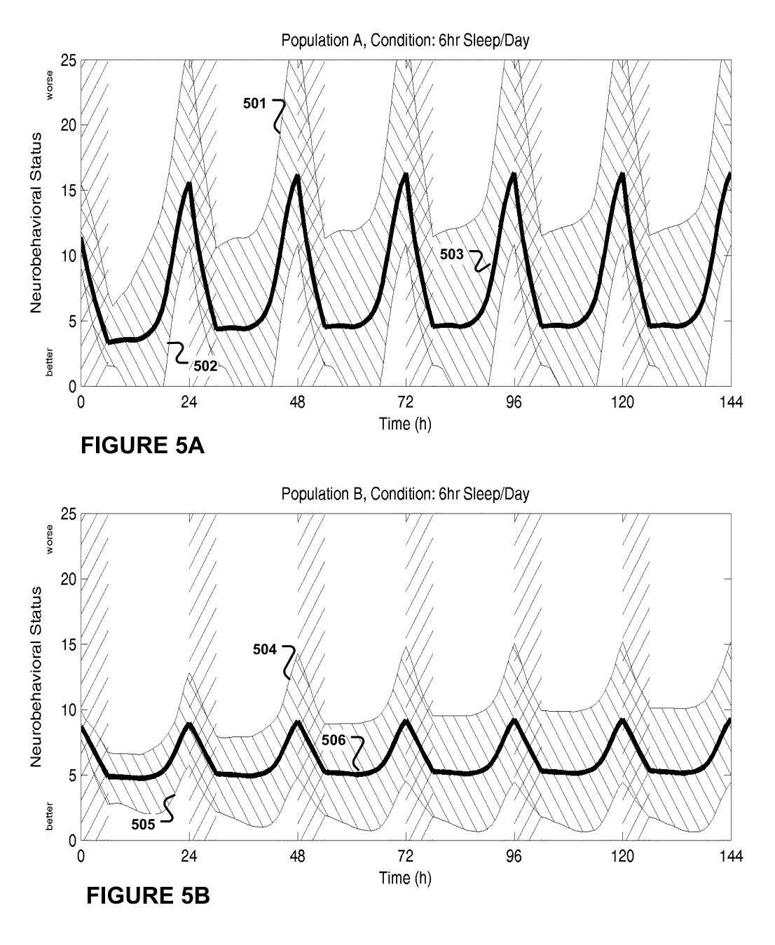

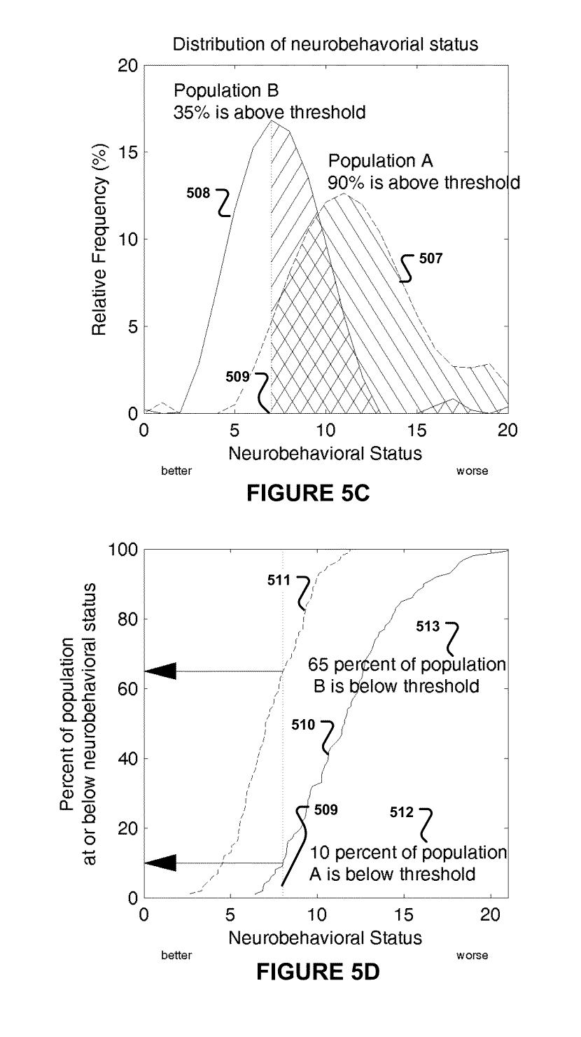

The multiple views of FIG. 5 provide non-limiting examples of step-107 determined comparisons 1000 of the neurobehavioral status 806 of the first population 802 to the neurobehavioral status 906 of the second population 902, in accordance with particular embodiments, wherein both the first and the second populations 802, 902 comprises populations (whether the same or different populations). Specifically, FIG. 5A provides a multi-day chart illustrating the neurobehavioral status (e.g., fatigue state) of a first population 802. The neurobehavioral status of first population 802 is illustrated as a set of three (3) distinct neurobehavioral status graph 501, 502, 503. Neurobehavioral status graphs 501 and 502 represent the outer boundaries of the neurobehavioral status of first population 802 over the time frame indicated. Neurobehavioral status graph 503 represents an average or mean neurobehavioral performance of first population 802.

Similarly, FIG. 5B provides a multi-day chart illustrating the neurobehavioral performance of a second population 902. The neurobehavioral status of second population 902 is illustrated as a set of three (3) distinct neurobehavioral status graph 504, 505, 506. Neurobehavioral status graphs 504 and 505 represent the outer boundaries of the neurobehavioral status of second population 902 over the time frame indicated. Neurobehavioral status graph 506 represents an average or mean neurobehavioral performance of second population 902.

Regarding respective neurobehavioral statuses 806, 906 of populations 802 and 902, FIG. 5C provides a non-limiting way in which to determine the comparison 1000 in step 107 of method 100. Graphs 507 and 508 are histograms of neurobehavioral performance scores for each member of first population 802 and second population 902, respectively. Boundary 509 represents an arbitrary threshold (perhaps dictated by operational objectives, industry or legal standards, or mere custom). A display report might be given in which a percentage above or below threshold 902 may be indicated.

Another non-limiting comparison 1000 is shown in FIG. 5D. Graphs 510 and 511 are cumulative distribution functions for first and second populations 802, 902, respectively, indicating the percentage of each population below a particular neurobehavioral status level. Arbitrary boundary 509 is also illustrated. A display report might be given in which a percentage of each population 802, 902 above or below threshold 509 may be indicated, such as display reports 512, 513 respectively. Other non-limiting examples of comparisons 1000 between first and second populations 802 and 902, wherein second population 902 comprises an individual include: a percentage of the first population with a neurobehavioral status above or below the neurobehavioral status of the individual, a number of individuals within the first population with a neurobehavioral status above or below the neurobehavioral status of the individual, a ratio of the number of individuals within the first population with a neurobehavioral status above the neurobehavioral status of the individual to the number of individuals within the first population with a neurobehavioral status below the neurobehavioral status of the individual, and/or the like.

The multiple views of FIG. 6 provide non-limiting examples of step-107 determined comparisons 1000 of the neurobehavioral status 806 of the first population 802 to the neurobehavioral status 906 of the second population 902, in accordance with particular embodiments, wherein the first population 802 comprises an individual. Specifically, FIG. 6A provides a corresponding multi-day chart for first population 802, wherein first population 802 comprises an individual. Neurobehavioral status graph 601 therefore represents the neurobehavioral status of the individual comprising first population 802 over the time frame indicated.

FIG. 6B provides a multi-day chart illustrating the neurobehavioral performance of a second population 902. The neurobehavioral status of second population 902 is illustrated as a set of three (3) distinct neurobehavioral status graph 602, 603, 604. Neurobehavioral status graphs 602 and 603 represent the outer boundaries of the neurobehavioral status of second population 902 over the time frame indicated. Neurobehavioral status graph 604 represents an average or mean neurobehavioral performance of second population 902.

Regarding respective neurobehavioral statuses 806, 906 of populations 802 and 902, FIG. 6C provides one non-limiting way in which to conduct the comparison 1000 in step 107 of method 100. FIG. 6C is a histogram 605 of neurobehavioral performance scores for each member of second population 902. The neurobehavioral performance score 606 for the individual comprising first population 802 is illustrated as well. A display report might be provided in which a ranking of the individual comprising first population 802 may be given with respect to the neurobehavioral performance distribution of second population 902.

Another non-limiting comparison 1000 is shown in FIG. 6D. Graph 608 is a ranking of all members of second populations 902 according to their neurobehavioral status level. The neurobehavioral status level 608 of the individual comprising first population 802 is also depicted and corresponds to the neurobehavioral status level 609 of the individual. A display report 611 might be provided in which a numerical ranking of the individual comprising first population 802 may be given with respect to the neurobehavioral performance distribution of second population 902 (e.g., 77th of 100, as shown).

Additional comparisons 1010 may be determined in any of the same or similar fashions as comparisons 1000 are determined and as illustrated in the foregoing multiple views of FIG. 3 through the multiple views of FIG. 6 (and associated discussion herein). Additional comparisons 1010 differ from comparisons 1000 only in that additional comparisons 1010 comprise a comparison of the neurobehavioral status one or more of the first and second population under the first set of testing conditions with the neurobehavioral status of one or more of the first and second populations under the second set of testing conditions. In all other respects, additional comparisons 1010 are the same as comparisons 1000.

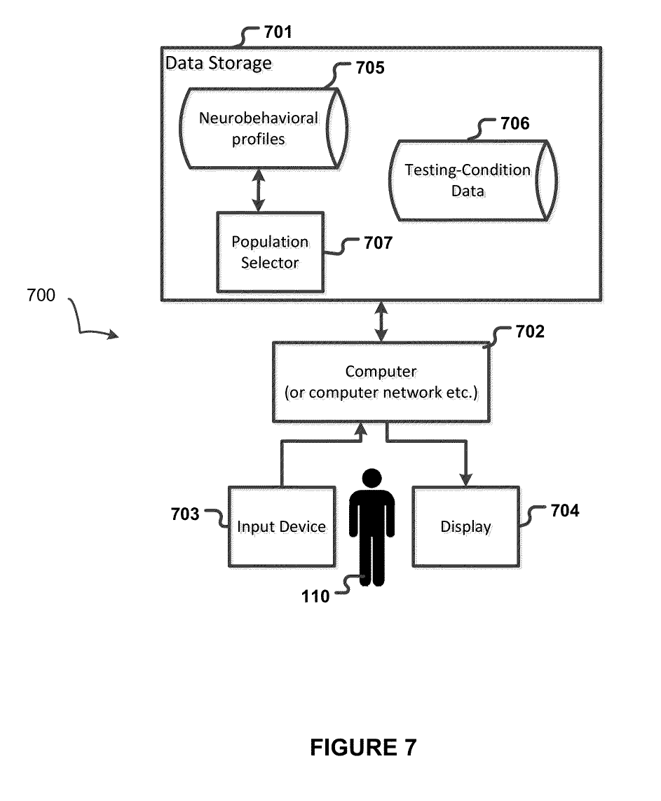

Particular embodiments of the invention may be implemented using suitably configured computer systems. FIG. 7 shows a schematic illustration of a system 700 for determining a comparison of first and second neurobehavioral statuses, according to a particular, non-limiting, embodiment. The illustrated system 700 comprises: data storage 701, a computer or computer network 702 (e.g. any device with suitable processing capacity and I/O capabilities, including networked computers, intranets, the Internet, mobile computing platforms, embedded devices, etc.), input device 703, and a display 704. In some implementations, some of these components may be the components that make up a personal computer, a mobile phone, personal media player, or any other device that contains the four aforementioned basic components. Data storage 701 may optionally contain neurobehavioral profiles 705 (optionally organized into a database, as shown), testing-condition data 706, a population selector 707 for associating specific populations to particular neurobehavioral profiles, and system software 708 (not shown). System software 708, when executed by computer 702, can cause computer 702 to perform the methods described herein. Neurobehavioral profiles 705, testing-condition data 706, and population selector 707 for associating specific populations to particular neurobehavioral profiles can all be utilized by computer 702 when performing such methods. Neurobehavioral profiles 705 may optionally comprise neurobehavioral performance models (as described herein).

Certain implementations of the invention may be used in medical diagnosis and/or medical treatment. Medical diagnostic embodiments may comprise assigning the patient to first population 802 and a reference healthy population to second population 902. The reference population may share one or more demographic or health-related characteristics in common with the patient, and comparisons of neurobehavioral performance may then be able to detect substantial deviations from reference population norms. Continued comparisons to the reference population throughout the monitoring, screening, diagnosis, or treatment phase of medical care may also be facilitated by the presently disclosed invention.

Certain implementations may also focus on the individualization of a countermeasure training regimen. Use of countermeasures constitutes an external condition under certain embodiments (see, e.g., FIG. 2D). By repeated application of the methods for comparing neurobehavioral performance among a countermeasure-maximizing subject and either him-/herself or a reference population, finding optimized countermeasure strategies (e.g., precise stimulant dosage) for varying external conditions may be found. Such applications can be of particular use for military during training, deployment and post-deployment when personnel are readjusting to civilian life where stimulant overuse and/or addiction may exist. For instance, the presently disclosed invention may assist such individuals taper their stimulant consumption while maintaining an acceptable neurobehavioral performance relative to a population-based standard (e.g., performance of their troop or platoon, performance of other military personnel with similar demographics, etc.).

Certain implementations of the invention comprise computer processors which execute software instructions which cause the processors to perform a method of the invention. For example, one or more processors may implement data processing steps in the methods described herein by executing software instructions retrieved from a program memory accessible to the processors. The invention may also be provided in the form of a program product. The program product may comprise any medium which carries a set of computer-readable instructions which, when executed by a data processor, cause the data processor to execute a method of the invention. Program products according to the invention may be in any of a wide variety of forms. The program product may comprise, for example, physical media such as magnetic data storage media including floppy diskettes, hard disk drives, optical data storage media including CD ROMs and DVDs, electronic data storage media including ROMs, flash RAM, or the like. The instructions may be present on the program product in encrypted and/or compressed formats.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e. that is functionally equivalent), including components which are not structurally equivalent to the disclosed structure which performs the function in the illustrated exemplary embodiments of the invention.

As will be apparent to those skilled in the art in light of the foregoing disclosure, many alterations and modifications are possible in the practice of this invention without departing from the spirit or scope thereof.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A method employing neurobehavioral profiles with a computer for determining a comparison of the neurobehavioral status of a first population relative to the neurobehavioral status of a second population, the method comprising:
receiving, at a computer, a first neurobehavioral profile for a first population, the first neurobehavioral profile indicating a neurobehavioral status of the first population corresponding to a set of testing conditions;
receiving, at the computer, a second neurobehavioral profile for a second population, the second neurobehavioral profile indicating a neurobehavioral status of the second population corresponding to a set of testing conditions;
receiving, at the computer, a first set of testing-condition data, the first set of testing-condition data being indicative of a first set of testing conditions;
determining, with the computer, a neurobehavioral status for the first population associated with the first set of testing conditions, wherein the neurobehavioral status for the first population associated with the first set of testing conditions is based at least in part on the received first neurobehavioral profile and the received first set of testing-condition data;
determining, with the computer, a neurobehavioral status for the second population associated with the first set of testing conditions, wherein the neurobehavioral status for the second population associated with the first set of testing conditions is based at least in part on the received second neurobehavioral profile and the received first set of testing-condition data; and
determining, with the computer, a comparison of the determined neurobehavioral status of the first population associated with the first set of testing conditions relative to the determined neurobehavioral status of the second population associated with the first set of testing conditions.

2. A method according to claim 1 wherein the received first neurobehavioral profile comprises at least in part one or more neurobehavioral trait values.

3. A method according to claim 2 wherein determining the neurobehavioral status for the first population associated with the first set of testing conditions comprises applying a neurobehavioral performance model to the first neurobehavioral profile and the first set of testing-condition data.

4. A method according to claim 1 wherein the received first neurobehavioral profile comprises at least in part one or more neurobehavioral performance values each associated with one or more testing conditions.

5. A method according to claim 4 wherein determining the neurobehavioral status for the first population associated with the first set of testing conditions comprises identifying neurobehavioral performance values with associated testing conditions that match the testing conditions indicated by the received first set of testing-condition data.

6. A method according to claim 1:
wherein the received second neurobehavioral profile comprises at least in part one or more neurobehavioral trait values, and
wherein determining the neurobehavioral status for the first population associated with the first set of testing conditions comprises applying a neurobehavioral performance model to the first neurobehavioral profile and the first set of testing-condition data.

7. A method according to claim 1:
wherein the received second neurobehavioral profile comprises at least in part one or more neurobehavioral performance values each associated with one or more testing conditions; and
wherein determining the neurobehavioral status for the second population associated with the first set of testing conditions comprises selecting neurobehavioral performance values with associated testing conditions that match the testing conditions indicated by the received first set of testing-condition data.

8. A method according to claim 1 wherein the first set of testing-condition data corresponds to a first time of interest, and further comprises:
receiving, at the computer, a second set of testing-condition data, the second set of testing-condition data being indicative of a second set of testing conditions corresponding to a second time of interest;
determining, with the computer, a neurobehavioral status for the first population associated with the second set of testing conditions, wherein the neurobehavioral status for the first population associated with the second set of testing conditions is based at least in part on the received first neurobehavioral profile and the received second set of testing-condition data;
determining, with the computer, a neurobehavioral status for the second population associated with the second set of testing conditions, wherein the neurobehavioral status for the second population associated with the second set of testing conditions is based at least in part on the received second neurobehavioral profile and the received second set of testing-condition data; and
determining, with the computer, one or more of:
a comparison of the determined neurobehavioral status of the first population associated with the first set of testing conditions relative to the determined neurobehavioral status of the first population associated with the second set of testing conditions,
a comparison of the determined neurobehavioral status of the first population associated with the second set of testing conditions relative to the determined neurobehavioral status of second the population associated with the second set of testing conditions, and
a comparison of the determined neurobehavioral status of the second population associated with the first set of testing conditions relative to the determined neurobehavioral status of the second population associated with the second set of testing conditions.

9. A method according to claim 1 wherein the first population comprises an individual.

10. A method according to claim 1 wherein the second population comprises an individual.

11. A method according to claim 1 either wherein the first population is a subset of the second population or wherein the second population is a subset of the first population.

12. A method according to claim 11 either wherein the first population comprises a plurality of individuals and the second population comprises an individual selected from the first population or wherein the second population comprises a plurality of individuals and the first population comprises an individual selected from the second population.

13. A method according to claim 13 wherein the first population and the second population comprise the same individual.

14. A method according to claim 1 wherein the first population and the second population are the same population.

15. A method according to claim 1 wherein the determined comparison of the determined neurobehavioral status of the first population associated with the first set of testing conditions relative to the determined neurobehavioral status of the second population associated with the first set of testing conditions comprises one or more of:
a difference in one or more statistical measures of the determined neurobehavioral status of the first population associated with the first set of testing conditions and the determined neurobehavioral status of the second population associated with the first set of testing conditions, and
a ratio of the number of individuals of the first population with a neurobehavioral status above or below a threshold to the number of individuals of the second population with a neurobehavioral status above or below the threshold.

16. A method according to claim 9 wherein the determined comparison of the determined neurobehavioral status of the first population associated with the first set of testing conditions relative to the determined neurobehavioral status of the second population associated with the first set of testing conditions comprises one or more of:
a percentile raking of the individual with respect to the second population,
a numerical ranking of the individual with respect to the second population,
a percentage of the second population with neurobehavioral response above or below the neurobehavioral status of the individual, and
the number of members of the second population with neurobehavioral status above or below the neurobehavioral response of the individual.

17. A method according to claim 10 wherein the determined comparison of the determined neurobehavioral status of the first population associated with the first set of testing conditions relative to the determined neurobehavioral status to the second population associated with the first set of testing conditions comprises one or more of:
a percentage of the first population with a neurobehavioral status above or below the neurobehavioral status of the individual,
a number of individuals within the first population with a neurobehavioral status above or below the neurobehavioral status of the individual, and
a ratio of the number of individuals within the first population with a neurobehavioral status above the neurobehavioral status of the individual to the number of individuals within the first population with a neurobehavioral status below the neurobehavioral status of the individual.

18. A method according to claim 6 wherein the first population and the second population comprise the same individual, and wherein one or more of:
the determined comparison of the determined neurobehavioral status of the first population associated with the first set of testing conditions relative to the determined neurobehavioral status of the first population associated with the second set of testing conditions, and
the determined comparison of the determined neurobehavioral status of the second population associated with the first set of testing conditions relative to the determined neurobehavioral status of the second population associated with the second set of testing conditions;
comprises one or more of:
a difference in neurobehavioral status of the individual under the first and the second sets of testing conditions,
a percentage change in neurobehavioral status of the individual under the first and the second sets of testing conditions, and
a recommended countermeasure to improve neurobehavioral performance to a particular threshold under either the first or the second sets of testing conditions.

19. A method according to claim 1 wherein the first population comprises a first individual, wherein the second population comprises a second individual, and wherein the determined comparison of the determined neurobehavioral status of the first population associated with the first set of testing conditions relative to the determined neurobehavioral status to the second population associated with the first set of testing conditions comprises one or more of:
a difference in determined neurobehavioral status of one or more of the first and second individual under one or more of the first and second set of testing conditions,
a percentage change in determined neurobehavioral status of one or more of the first and second individual under one or more of the first and second set of testing conditions, and
a recommended countermeasure for one or more of the first and second individuals to improve neurobehavioral performance to a particular threshold.

20. A method according to claim 8 wherein the first set of testing conditions and the second set of testing conditions are the same set of testing conditions.

21. A method according to claim 8 wherein the first time of interest and the second time of interest are the same or a comparable time of interest.

22. A method according to claim 1 wherein one or more of the first neurobehavioral profile and the second neurobehavioral profile comprise one or more pairs of statistical parameters corresponding to the distribution of first and second sets of neurobehavioral traits across the first and second populations, respectively.

23. A method according to claim 1 wherein one or more of the first neurobehavioral profile and the second neurobehavioral profiles comprises one or more normal distributions of a neurobehavioral trait across the first and second populations, respectively.

24. A method according to claim 22 wherein the one or more pairs of statistical parameters comprises one or more of: a mean and a variance; and a median and a standard deviation.

25. A method according to claim 1 wherein at least one of the first population and the second population comprises at least one of a workforce, a military unit, a plurality of individuals with shared demographics, a plurality of individuals with one or more shared medical conditions, an experimental group in research, and a control group in research.

26. A method according to claim 1 wherein the first set of testing conditions comprise one or more of: sleep and work history, external factors, dosing or application of neurobehavioral countermeasures, and presence of neurobehavioral stressors.

27. A method according to claim 26 wherein the sleep and work history data comprises one or more of: actigraphy, a sleep schedule, one or more sleep onset times, one or more sleep interval durations, a duration of total time in bed over an extended period, a work schedule, one or more work shift identifiers, one or more work start times, one or more work interval durations, and a duration of total work time over an extended interval.

28. A method according to claim 26 wherein the external factors comprise one or more of: weather data, environmental data, and noise or sound data.

29. A method according to claim 26 wherein the dosing or application of neurobehavioral countermeasures comprises one or more of: a schedule of stimulant ingestion, a sleep schedule, a schedule of physical activity, and an exercise schedule.

30. A method according to claim 26 wherein the existence of neurobehavioral stressors comprises the existence of one or more of: prolonged wakefulness, circadian misalignment, extended time on duty, and night work.

31. A method according to claim 26 wherein the first set of testing-condition data corresponds to a first time of interest, and the first time of interest comprises a time related to when one or more members of the first population: report for work, report for military duty, undergo medical examination, undergo medical treatment, drive a vehicle, operate machinery, undergo physical activity, undergo athletic competition, enroll in the military from civilian life, resume civilian life after military duty, and engage in a task with an identifiable neurobehavioral or fatigue risk.

32. A method according to claim 1 wherein the first set of testing-condition data corresponds to a the first time of interest, the first time of interest comprising one or more of a time interval, a plurality of time intervals, an exact time, and a plurality of exact times.

33. A method according to claim 8 wherein the second time of interest represented by the received first set of testing-condition data comprises a time related to when one or more members of the first population: report for work, report for military duty, undergo medical examination, undergo medical treatment, drive a vehicle, operate machinery, undergo physical activity, undergo athletic competition, enroll in the military from civilian life, resume civilian life after military duty, and engage in a task with an identifiable neurobehavioral or fatigue risk.

34. A method according to claim 1 wherein one or more of the determined neurobehavioral status for the first population associated with the first set of testing conditions and the determined neurobehavioral status for the second population associated with the first set of testing conditions comprise neurobehavioral performance assessment metrics for one or more of: the psychomotor vigilance test, the motor praxis test, the visual object learning test, the fractal-2-back test, the conditional exclusion task, the matrix reasoning task, the line orientation test, the emotion recognition test, the balloon analog risk task, the digit symbol substitution test, the forward digit span, the reverse digit span, the serial addition and subtraction task, the go/no-go task, the word-pair memory task, the word recall test, the motor skill learning task, the threat detect test, the descending subtraction task, the PANAS-X questionnaire, the pre-sleep/post-sleep questionnaires for astronauts, the Beck depression inventory, the conflict questionnaire, the Karolinska drowsiness scales, the visual analog scales, the Karolinska sleepiness scales, the POMS/POMS-SF questionnaires, and the Stroop test.

35. A method according to claim 1 wherein one or more of the determined neurobehavioral status for the first population associated with the first set of testing conditions and the determined neurobehavioral status for the second population associated with the first set of testing conditions comprise neurobehavioral performance assessment metrics for one or more of: a workplace-specific task, a standardized line-of-work task, a special tasks, and performance as measured by an embedded performance monitoring system.

36. A method according to claim 2 wherein the biomathematical model comprises the two-process model of fatigue prediction.

37. A method according to claim 36 wherein the one or more neurobehavioral traits values comprising the first neurobehavioral profile comprise values for one or more of: φ, γ, τ, a₁, ρ_{w}, ρₛ, κ, and ε.

38. A method according to claim 2 wherein the biomathematical model comprises one or more of: the three-process model of alertness, the two-process model revisited, the process-U model, the modified two-process model, the QinetiQ approach, the circadian alertness simulator, the new model class, nonparametric approaches, and neural networks.

39. A method according to claim 2 wherein the one or more of neurobehavioral trait values comprise values for one or more of:
daily sleep need,
whether the testing subject is relatively more alert late at night or relatively more alert in the early morning,
medical disorder severity,
sleep inertia severity,
drug sensitivity,
response bias,
the degree of performance deficits associated with occurrence of or varying degrees of night work,
the degree of performance deficits associated with occurrence of or varying degrees of extended wakefulness,
the degree of performance deficits associated with occurrence of or varying degrees of chronic sleep restriction,
the degree of performance deficits associated with occurrence of or varying degrees of shift work,
the degree of performance deficits associated with occurrence of or varying degrees of extended time on task,
the degree of performance deficits associated with occurrence of or varying degrees of jet lag,
the degree of performance deficits associated with occurrence of or varying degrees of shifts in sleep schedule,
the degree of performance deficits associated with occurrence of or varying degrees of sleep disruption,
the degree of performance deficits associated with occurrence of or varying degrees of medical disorders,
the degree of performance deficits associated with occurrence of or varying degrees of sleep disorders,
the degree of performance deficits associated with occurrence of or varying degrees of medical treatments,
rate of change of the testing subject's performance during extended wakefulness,
rate of change of the testing subject's performance across multiple days of restricted sleep,
recovery rate of performance for the testing subject during sleep,
extent that time of day influences the performance level of the testing subject, and
an aptitude of the testing subject for a specific performance task.

40. A computer program product embodied in a non-transitory medium and comprising computer-readable instructions that, when executed by a suitable computer, cause the computer to perform a method for determining a comparison of the neurobehavioral status of a first population relative to the neurobehavioral status of a second population, the method comprising:
receiving, at a computer, a first neurobehavioral profile for a first population, the first neurobehavioral profile indicating a neurobehavioral status of the first population corresponding to a set of testing conditions;
receiving, at the computer, a second neurobehavioral profile for a second population, the second neurobehavioral profile of indicating a neurobehavioral status of the second population corresponding to a set of testing conditions;
receiving, at the computer, a first set of testing-condition data, the first set of testing-condition data being indicative of a first set of testing conditions;
determining, with the computer, a neurobehavioral status for the first population associated with the first set of testing conditions, wherein the neurobehavioral status for the first population associated with the first set of testing conditions is based at least in part on the received first neurobehavioral profile and the received first set of testing-condition data;
determining, with the computer, a neurobehavioral status for the second population associated with the first set of testing conditions, wherein the neurobehavioral status for the second population associated with the first set of testing conditions is based at least in part on the received second neurobehavioral profile and the received first set of testing-condition data; and
determining, with the computer, a comparison of the determined neurobehavioral status of the first population associated with the first set of testing conditions relative to the determined neurobehavioral status of the second population associated with the first set of testing conditions.

41. A system for determining a comparison of the neurobehavioral status of a first population relative to the neurobehavioral status of a second population, the system comprising:
a data storage unit, the data storage unit containing a database of neurobehavioral profiles and a database of testing-condition data,
a processor capable of receiving neurobehavioral profiles and testing-condition data from the data storage unit,
wherein determining a comparison of the neurobehavioral status of a first population relative to the neurobehavioral status of a second population comprises:
receiving, at a computer, a first neurobehavioral profile for a first population, the first neurobehavioral profile indicating a neurobehavioral status of the first population corresponding to a set of testing conditions;
receiving, at the computer, a second neurobehavioral profile for a second population, the second neurobehavioral profile of indicating a neurobehavioral status of the second population corresponding to a set of testing conditions;
receiving, at the computer, a first set of testing-condition data, the first set of testing-condition data being indicative of a first set of testing conditions;
determining, with the computer, a neurobehavioral status for the first population associated with the first set of testing conditions, wherein the neurobehavioral status for the first population associated with the first set of testing conditions is based at least in part on the received first neurobehavioral profile and the received first set of testing-condition data;
determining, with the computer, a neurobehavioral status for the second population associated with the first set of testing conditions, wherein the neurobehavioral status for the second population associated with the first set of testing conditions is based at least in part on the received second neurobehavioral profile and the received first set of testing-condition data; and
determining, with the computer, a comparison of the determined neurobehavioral status of the first population associated with the first set of testing conditions relative to the determined neurobehavioral status of the second population associated with the first set of testing conditions.
